(19) United States
(12) Patent Application Publication
(10) Pub. No.: US 2009/0152484 A1
(43) Pub. Date: Jun. 18, 2009

(54) Tamper-proof valve locking device

(76) Inventors: Ronald LeBlanc, Memramcook (CA); Alfred Babineau, Dieppe New Brunswick (CA)

Correspondence Address: KELLEY DRYE & WARREN LLP, 3050 K STREET, NW, SUITE 400, WASHINGTON, DC, 20007, US

(21) Appl. No.: 12/000,619

(22) Filed: Dec. 14, 2007

(51) Int. Cl. F16K 35/02

(52) U.S. Cl. 251/98

(57) ABSTRACT

A device for locking a valve having an integrated stopper on the valve body and a valve handle with a locking hole in either an open or a closed position is disclosed. The valve handle is adapted to pivot a central valve post to rotate the valve between the open and closed positions. The device may include a rigid body having a central portion, and first and second arms extending outward from the central portion. Two holes may be provided in the arms to register with the locking hole in the valve handle and a third hole in the central portion of the rigid body may receive the central valve post. A notch sized to securely receive the integrated stopper may be provided in the central portion of the rigid body.

### FIELD OF THE INVENTION

The present invention relates to a device for locking or anti-tampering, and particularly a device for locking a valve with a handle in either an open or a closed position.

### BACKGROUND OF THE INVENTION

In some fluid flow systems, the operating position of a particular regulating valve may be critical to the proper functioning of the system. The improper operation or positioning of such a valve may result in a complete malfunction of the system, often with serious and dangerous consequences. For this reason, it is often desirable to securely lock the fluid-flow valve at one or more operating positions to prevent tampering and unauthorized or inadvertent operation of the valve. For example, one kind of fluid flow valve is a medical gas ball valve, which resides on the top of a canister of a tank of gas for use in medical environments and in all medical gas building piping systems upstream and downstream from zone valves, as indicated in the medical gas code. Medical gas ball valves need handles to securely lock the valve in either an open or a closed position for safety and proper operation as well as to prevent tampering.

A secure lock is important, because some existing mechanisms for valve locking do not lock securely, swiveling and permitting play between parts. For example, U.S. Pat. No. 5,368,066 to Scaramucci discloses a lock plate that engages a stop pin. The stop pin has a round surface that is susceptible to being deformed or sheared off because the round surface of the stop pin meets the flat surface of the lock plate. Furthermore, the round stop pin would not lock securely, permitting play between parts.

In addition to a secure lock, it is desirable to retrofit a valve with a locking device that can easily be installed without disturbing the operation of the fluid flow system. Accordingly, there is a need for a device that provides a secure lock, can be retrofitted onto various valves and can be installed on new valves as well.

### SUMMARY OF THE INVENTION

Responsive to the foregoing challenges, a device for locking a valve having an integrated stopper on the valve body and a valve handle with a locking hole in either an open and a closed position is provided. The valve handle is adapted to pivot about a central valve post to rotate the valve between the open and closed positions. The device includes a rigid body having a central portion, and first and second arms extending outward from the central portion. A first hole is provided in the first arm such that the first hole registers with the locking hole in the valve handle when the first arm and the valve handle are aligned to place the valve in the open position. A second hole is provided in the second arm such that the second hole registers with the locking hole in the valve handle when the second arm and the valve handle are aligned to place the valve in the closed position. A third hole is provided in the central portion of the rigid body, which is adapted to receive the central valve post. A notch is provided in the central portion of the rigid body. The notch is sized to securely receive the integrated stopper such that the rigid body is substantially prevented from rotating in any direction in the event that a lateral force is applied to the rigid body. The rigid body may have an L-shape. The integrated stopper may have a substantially rectangular cross section defining at least two opposing flat surfaces and the notch may include flat interior opposing shoulders adapted to securely engage the opposing flat surfaces of the integrated stopper. The first and second holes may be substantially the same diameter as the locking hole. The first hole, the second hole, and the locking hole may be sized to receive a lock gate such that the rotation of the valve handle is substantially prevented when the lock gate extends through the first hole and the locking hole or through the second hole and the locking hole. The first and second arms may include inclined portions and the first and second holes may be provided in the inclined portions of the first and second arms, respectively.

It is to be understood that both the foregoing general description and the following detailed description are exemplary and explanatory only, and are not restrictive of the invention as claimed.

### BRIEF DESCRIPTION OF THE DRAWINGS

In order to assist the understanding of this invention, reference will now be made to the appended drawings, in which like reference characters refer to like elements.

FIG. 1A is a top view of an exemplary embodiment of a valve locking device.

FIG. 1B is a side view of the exemplary embodiment of the valve locking device of FIG. 1A.

FIG. 2A is a top view of an exemplary valve on which an embodiment of a valve locking device may be installed.

FIG. 2B is a first side view of the exemplary valve of FIG. 2A.

FIG. 2C a second side view of the exemplary valve of FIG. 2A.

FIG. 3 is an exploded perspective view of an exemplary assembly including the exemplary embodiment of the valve locking device of FIG. 1A and the exemplary valve of FIG. 2A.

FIG. 4 is a partial, detail view illustrating how the notch of the valve locking device of FIG. 1A mates with the integrated stopper of the exemplary valve of FIG. 2A.

### DETAILED DESCRIPTION OF EMBODIMENTS

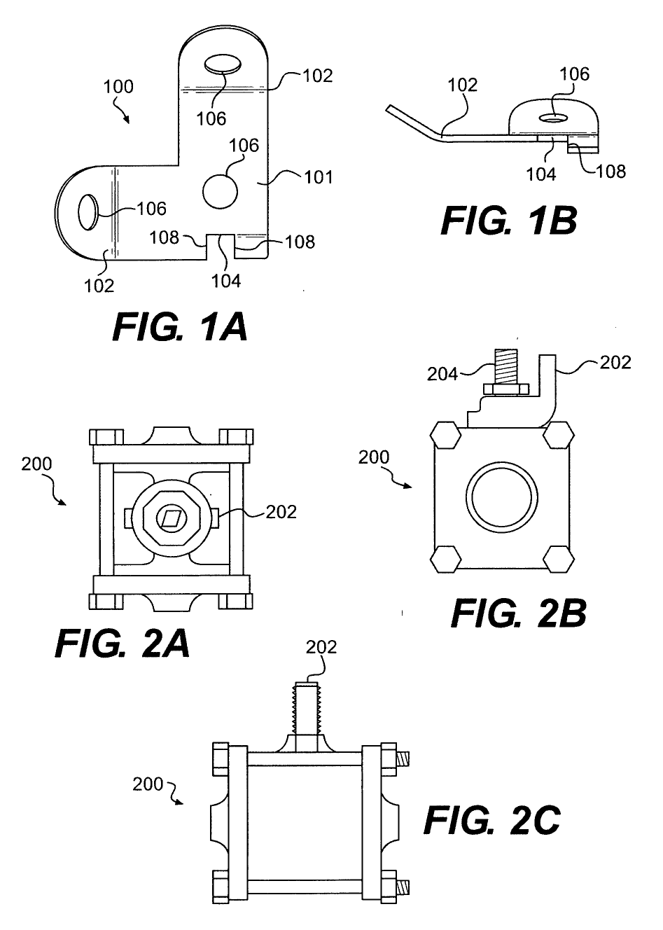

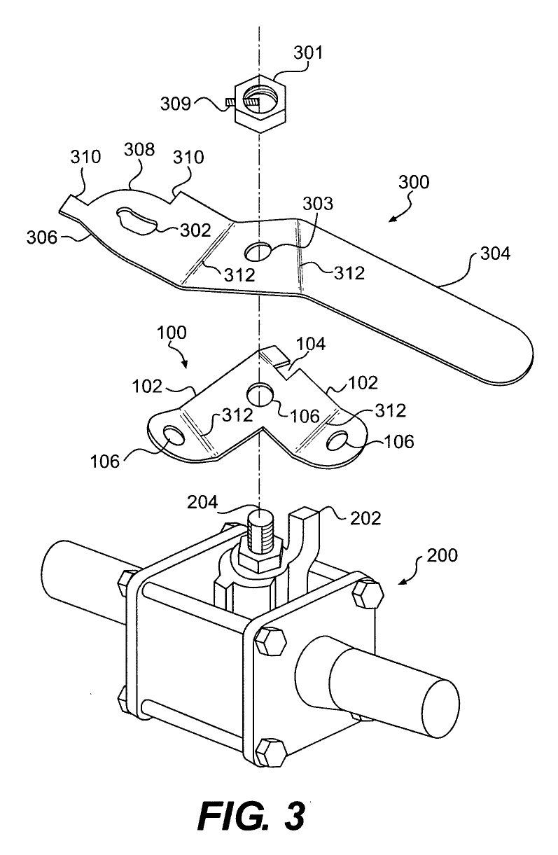

Reference will now be made in detail to a first embodiment of the present invention, an example of which is illustrated in the accompanying drawings. With reference to FIGS. 1A and 1B, a top and side view respectively of an exemplary embodiment of a valve locking device 100 are shown. The valve locking device 100 may be fitted between a valve and a valve handle for the valve as shown in FIG. 3.

The valve locking device 100 may include a rigid body having a central portion 101, two arms 102 extending outward from the central portion and a notch 104 in the central portion. The valve locking device 100 may be any kind of rigid body, such as an L-shaped bracket and may have various shapes, sizes and orientations. The arms 102 may extend outward in directions towards the open and closed positions. The notch 104 may be shaped to mate with an integrated stopper on the valve to lock the valve with the valve handle in either the open or the closed position. The valve locking device 100 may include several holes 106. There is one hole 106 in one arm 102 for locking the valve in an open position and another hole 106 in the other arm 102 for locking the valve in a closed position. The valve locking device 100 may have a third hole 106 between the arms at the central portion for receiving a central valve post 204 and for fastening the valve locking device 100 between the valve and the valve handle (described below, see FIG. 3).

FIGS. 2A, 2B and 2C are top, end and side views respectively of an exemplary valve 200 on which the valve locking device 100 may be installed. This exemplary valve 200 may be a medical gas ball valve; however embodiments of the present invention may be used with various kinds of fluid flow valves. It is to be understood that the valve 200 illustrated in the figures is merely representative of a large variety of fluid flow valves operated with a valve handle that may be retrofitted with embodiments of the valve locking device 100. The valve 200 may include an integrated stopper 202 and a central valve post 204.

The integrated stopper 202 on the valve 200 may securely engage the notch 104 of the valve locking device 100 to keep the valve locking device from rotating and thereby allowing the valve 200 with the valve handle 300 to be locked in either the open or the closed position. The notch 104 in the central portion 101 of the valve locking device 100 may be sized to securely receive the integrated stopper 202 such that the valve locking device 100 is substantially prevented from rotating in any direction in the event that a lateral force is applied to the valve locking device 100. The valve locking device 100 preferably has a thickness such that the valve locking device 100 is incapable of being bent by standard human forces, yet thin enough to be received over the central valve post 204 and by the integrated stopper 202 and fastened between the valve handle 300 and the valve 200. A relatively tight tolerance mating of the notch 104 and the integrated stopper 202 may assist in reducing the ability of the valve locking device 100 to swivel or movie, i.e., play between the valve parts and the valve locking device is reduced or restricted to provide a secure lock. Preferably, a tampered set screw through a nut (see FIG. 3) is tightened on the shaft of the valve so that the valve cannot be removed, making the device tamper proof.

The central valve post 204 may receive the valve locking device 100 and the valve handle 300 (shown in FIG. 3). The central valve post 204 may pass through the hole 106 in the central portion 101 of the valve locking device 100 and the hole 302 in the selection end 306 of the valve handle 300. When the valve locking device 100 and the valve handle 300 are in place, the valve handle 300 is free to pivot the central valve post 204 to rotate the valve 200 between the open and closed positions.

FIG. 3 is an exploded perspective view of an exemplary assembly including the exemplary embodiment of the valve locking device 100 of FIG. 1A and the exemplary valve 200 of FIG. 2A. The valve 200 may have an integrated stopper 202 on the valve body and a valve handle 300 with a locking hole 303 for locking the valve in either an open or closed position. The valve locking device 100 may be fitted between the valve 200 and the valve handle 300, and both the valve locking device and the valve handle may be secured to the central post 204 with, for example, a fastening nut 301. Preferably, a tamper proof set screw 309 through the nut 301 is tightened on the shaft of the valve so that the valve handle including the locking plate cannot be removed, making the device tamper proof. Various other fastening, mounting or installing means may also be used. The valve locking device 100 may be installed on a valve 200 in either the open or closed position and may be installed while the valve 200 is in service so that no shut down is needed.

The valve handle 300 may comprise an elongated rigid body with a gripping end 304 and a selection end 306. The selection end 306 may include a selection edge 308 between two stops or shoulders 310. The valve handle 300 may rotate any number of degrees less than 360 (e.g., 90 degrees) along the selection edge 308 to select between one stop 310 at the open position and the other stop 310 at the closed position. The stops 310 of the valve handle 300 may be adapted to abut the integrated stopper 202 of the valve 200 in correspondence with the valve being in full open and full closed positions.

The valve handle 300 may have a hole or slot 302 in the selection end 306 that is adapted to receive the central valve post 204 of the valve 200 and a locking hole 303 in the gripping end 304 that may register with holes 106 in the first and second arms 102 of the valve locking device 100. The first hole 106 in the first arm 102 of the valve locking device 100 may register with the locking hole 303 in the valve handle 300 when the first arm 102 and the valve handle 300 are aligned to place the valve 200 in the open position. The second hole 106 in the second arm 102 may register with the locking hole 303 in the valve handle 300 when the second arm 102 and the valve handle are aligned to place the valve 200 in the closed position. When fastened down by the fastening nut 301, the valve handle 300 may pivot the central valve post 204 to rotate the valve 200 between the open and closed positions. Then, the gates (or shafts) of a lock (e.g., a Master brand style U-shaped padlock, not shown) may pass through the aligned holes to secure both the valve handle 300 and the valve locking device 100 together and thus lock the valve in either the open or the closed position. Preferably, the aligned holes are substantially the same size as the gates of the lock in order to restrict play and thus provide a more secure lock of the valve.

One or both of the valve handle 300 and the valve locking device 100 may include any number and placement of bends 312, inclines and the like for mating with each other, such as those shown in FIG. 3. The valve handle 300 and valve locking device 100 may have various shapes and orientations other than those illustrated in the figures. For example, they may have rounded or square corners. The valve locking device 100 may have metal on each side of the integrated stopper 202 that is bent down or flat.

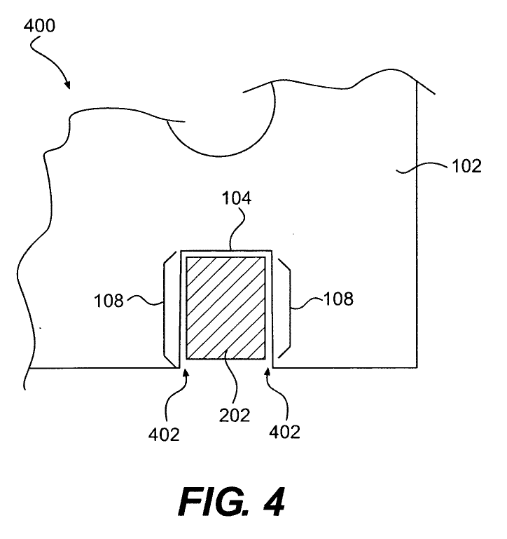

FIG. 4 is a partial, detail view 400 illustrating how the notch 104 of the valve locking device 100 may mate with and securely engage the integrated stopper 202 of the valve 200. The substantially flat surfaces of the notch 104 (such as the shoulders 108) may mate with the substantially flat surfaces of the integrated stopper 202, reducing and preferably preventing any unwanted rotation of the locking device and thus providing a secure locking function. Preferably, the spaces 402 between the notch 104 and the integrated stopper 202 are small enough to provide a secure locking function and to prevent unwanted rotation, play or wiggling.

Embodiments of the present invention have many advantages, including permitting the valve locking device 100 to be retrofitted on a large variety of existing valves easily without disturbing the fluid flow system in operation. The retrofitting may be done with a valve locking device 100 similar to the one shown in FIG. 1A for any size valve 200 with an integrated stopper 202 similar to the one shown in FIG. 3. For other, dissimilar stoppers 202, the shape, size and orientation of the notch 104 of the valve locking device 100 may be customized. Other locking mechanisms in the related art do not lock securely, while embodiments of the valve locking device 100 restrict play (or swivel) for a more secure lock.

It will be apparent to those skilled in the art that variations and modifications of the present invention can be made without departing from the scope or spirit of the invention. For example, size shape and materials may be changed without departing from the intended scope of the invention and appended claims. It is further appreciated that forming one or more elements of the apparatus embodiments of the present invention integrally as opposed to separately is intended to fall within the scope of the invention and appended claims.

What is claimed is:

1. A device for locking a valve having an integrated stopper on the valve body and a valve handle with a locking hole in an open and a closed position, said valve handle being adapted to pivot about a central valve post to rotate the valve between the open and closed positions, said device comprising:
a rigid body having a central portion and first and second arms extending outward from the central portion;
a first hole provided in the first arm such that said first hole registers with the locking hole in the valve handle when the first arm and the valve handle are aligned to place the valve in the open position;
a second hole provided in the second arm such that said second hole registers with the locking hole in the valve handle when the second arm and the valve handle are aligned to place the valve in the closed position;
a third hole provided in the central portion of the rigid body, said third hole being adapted to receive the central valve post; and
a notch provided in the central portion of the rigid body, said notch being sized to securely receive the integrated stopper such that the rigid body is substantially prevented from rotating in any direction in the event that a lateral force is applied to the rigid body.

2. The device of claim 1, wherein the rigid body has an L-shape.

3. The device of claim 1, wherein the integrated stopper has a substantially rectangular cross section defining at least two opposing flat surfaces, and wherein the notch includes flat interior opposing shoulders adapted to securely engage the at least two opposing flat surfaces of the integrated stopper.

4. The device of claim 1, wherein the first and second holes are substantially the same diameter as the locking hole, and the first hole, the second hole, and the locking hole are sized to receive a lock gate such that the rotation of the valve handle is substantially prevented when the lock gate extends through the first hole and the locking hole or through the second hole and the locking hole.

5. The device of claim 1, wherein the first and second arms include inclined portions and the first and second holes are provided in the inclined portions of the first and second arms, respectively.
